(19) United States
(12) Patent Application Publication
(10) Pub. No.: US 2007/0048708 A1
(43) Pub. Date: Mar. 1, 2007

(54) Motivational and educational enlarged abacus

(76) Inventor: Eric Lee, Fremont, CA (US)

Correspondence Address: Donald W. Meeker;Patent Agent, 924 East Ocean Front #E, Newport Beach, CA, 92661, US

(21) Appl. No.: 11/504,608

(22) Filed: Aug. 16, 2006

Related U.S. Application Data
(60) Provisional application No. 60/711,506, filed on Aug. 26, 2005.

(51) Int. Cl. G09B 19/00

(52) U.S. Cl. 434/236; 434/156

(57) ABSTRACT

A motivational and teaching abacus device which has large beads rotatably and slidably mounted on a rod for classroom or home display. Each bead has indicia on two opposite sides, a smiley face on a first side and a number in a series of numbers on a second side. Alternately, the indicia on the second side may comprise a letter of the alphabet. The beads and the indicia are sufficiently large to be seen by all students in a classroom. The device may be supported on a horizontal or vertical surface.

### CROSS-REFERENCE TO RELATED APPLICATIONS

This utility patent application claims the benefit of provisional application No. 60/711,506 filed Aug. 26, 2005.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to abacuses and particularly to a motivational and teaching abacus device having large beads slidably mounted on a rod for classroom or home display, each bead having indicia on two opposite sides, a smiley face on a first side and a number in a series of numbers on a second side, wherein the beads and the indicia are sufficiently large to be seen by all students in a classroom.

2. Description of Related Art Including Information Disclosed Under 37 CFR 1.97 and 1.98

The abacus is a device which usually has a frame that holds rods with freely-sliding and freely-rotatable beads mounted on them. The original use of an abacus was as a mechanical aid used for counting; not as calculators in the sense we use the word today. The person operating the abacus performed calculations in their head and used the abacus as a physical aid to keep track of the sums or the carrying of numbers. The abacus has long been used as a display device by teachers to help their students visualize and solve mathematical problems.

Teachers and parents have also used display devices to instill proper behavioral habits in children. The prior patents do not provide a combination teaching device and behavior influencing device in the form of an abacus.

Prior art U.S. Patent Application #20040197751, published Oct. 7, 2004 by Alexander, is for an assessment tool and method for evaluating a person's quality of life based on a plurality of personal attributes. The assessment tool includes a list of a plurality of personal attributes determined to be significant to a person's quality of life and means for establishing a score for each of the personal attributes for a selected person. A display representing the established score for each of the personal attributes is also provided, wherein the display provides a visual representation of the selected person's quality of life with respect to the personal attributes.

Prior art U.S. Pat. No. 5,190,459, issued Mar. 2, 1993 to Determan, relates a child's behavioral calendar apparatus that is arranged to include a support plate mounting an upper housing and lower housing thereto. The upper housing includes a first “W” shaped loop to accommodate one counting sphere for each day per week. A second inverted “U” shaped loop mounted to the second housing includes second spheres to accommodate four more spheres to indicate a corresponding number of misbehaviors of a number of days per week. A total of four more displacements of the second spheres effects the displacement in a week of one of a third sphere of a third loop to indicate a single week's behavior. Misbehavior of three or more such spheres effects displacement of the “W” shaped spheres to indicate in a calendar year the number of months of misbehavioral activity. A fourth inverted “U” shaped loop mounted to the second housing is arranged for calendar months corresponding movement of a single sphere per month to indicate whether a child has misbehaved a greater number of months and the current calendar month as indicated by the fourth loop. A modification of the invention includes the first and fifth “W” shaped loops formed of a translucent material to effect illumination of the loop for enhanced visibility as well as illumination of the pictorial designations rearwardly of the distal ends of each of the first and fifth loops.

Prior art U.S. Pat. No. 4,776,799, issued Oct. 11, 1988 to Walsh, provides a portable, self-contained, educational-organizational system and method employing such system. The system comprises a system body which, in the open position, has a longitudinally-extending, substantially flat configuration for hanging the system onto a vertical support surface. The system includes at least one visually-coded activity marker means arranged on a side of the system for listing on a daily activity listing means at least one designated daily activity to be performed by said user. This produces a completed daily activity listing means. A plurality of completed daily activity listing means arranged on the system side together comprise an organized educational plan. Also in the system are visually-coded indicator means for evidencing the completion status of each designated daily activity. This allows for recognition by the user of the completion of a series of given activities which make-up the plan.

Prior art U.S. Pat. No. 5,149,269, issued Sep. 22, 1992 to Ylitalo, shows a manual arithmetic teaching calculator consisting of a rod having hand movable spaced collars slidable thereon and having sequentially spaced numbers therealong corresponding to the collars whereby the numbers indicate visually the arithmetic calculation of preceeding manipulated numbers.

Prior art U.S. Pat. No. 5,334,026, issued Aug. 2, 1994 to Ylitalo, claims a manual sliding calculator. An early age abacus-type teaching device is provided which comprises a rod having movable counters thereon with corresponding sequentially spaced numerals therealong whereby the numerals are utilized to represent the calculation of the preceding manipulated counters and the rod is equipped at each end thereof with a device to support and hold the same upon a horizontally or vertically disposed surface.

Prior art U.S. Pat. No. 4,993,952, issued Feb. 19, 1991 to Yeh, describes an arithmetic counter that includes a U-shaped support structure for a horizontal rod. Consecutively numbered beads are slidably arranged on the rod for adjustment to positions wherein selected numbers of the beads are separated from the remaining beads. One or more marker boards are adopted to be hung from the rod between the separated beads and the remaining beads, such that a small child can count the beads and achieve and better understand “addition” and “subtraction” processes.

Prior art U.S. Pat. No. 541,787, issued Jun. 25, 1895 to Hegewald, indicates an apparatus for teaching math which comprises free-standing blackboard with an abacus at the top.

Prior art U.S. Pat. No. 560,651, issued May 26, 1896 to Rodelsperger, puts forth to a free-standing blackboard with an abacus at the top and at the side thereof for the purpose of teaching students arithmetic.

Prior art U.S. Pat. No. 1,099,009, issued Jun. 2, 1914 to Bennett, concerns a teaching abacus having a horizontal rod-like member with triangular supports on the ends thereof. The abacus has a plurality of slidable bead-like elements mounted on the rod-like member.

What is needed is a motivational and teaching abacus device having large beads slidably mounted on a rod for classroom or home display, each bead having indicia on two opposite sides a smiley face on a first side and a number in a series of numbers on a second side, wherein the beads and the indicia are sufficiently large to be seen by all students in a classroom.

### BRIEF SUMMARY OF THE INVENTION

An object of the present invention is to provide a motivational and teaching abacus device having large beads slidably mounted on a rod for classroom or home display, each bead having indicia on two opposite sides, a motivational indicia such as a smiley face on a first (front) side and an alphanumeric character indicia such as a number in a series of numbers or a letter of the alphabet on a second (back) side, wherein the beads and the indicia are sufficiently large to be seen by all students in a classroom.

In brief, a motivational and teaching method and abacus device which has large beads rotatably and slidably mounted on a rod for classroom or home display. Each bead has indicia on two opposite sides, a smiley face on a first side and a number in a series of numbers on a second side. The beads and the indicia are sufficiently large to be seen by all students in a classroom.

In the preferred Smileystick™ embodiment of the present invention, there are smiley faces on the front of the beads, which may be used to reward or motivate children, and numbers on the back side of the beads, to aid in teaching arithmetic students. Alternately, the Smileystick™ may have letters on the back side of the beads for teaching students the alphabet. The indicia on either side of the beads may alternately comprise numbers, characters or letters of a foreign language to teach a foreign language or further comprise a combination of languages to assist in teaching bilingual students or a secondary language. The indicia on either side of the bead may alternately comprise any symbol, such as but not limited to a star, which may be used as a reward or as a motivational tool.

An advantage of the present invention is that it is of a sufficient size to be viewed by all students in a classroom.

Another advantage of the present invention is that it can be used to teach arithmetic.

Yet another advantage of the present invention is that it can be used to teach the alphabet.

One more advantage of the present invention is that it can be used as a motivational tool.

An additional advantage of the present invention is that it can be used as a reward system.

A contributory advantage of the present invention is that it can be used to teach bilingual students or to teach a secondary language.

A further advantage of the present invention is that the indicia the bead helps to hold the student's attention on the lesson.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the motivational and teaching abacus device of the present invention showing the large beads slidably mounted on a rod with dual function triangular mounting blocks at each end shown resting on a horizontal surface;

FIG. 2 is a perspective view of the motivational and teaching abacus device of FIG. 1 the present invention showing the large beads slidably mounted on a rod with dual function triangular mounting blocks at each end shown mounted on a vertical surface;

FIG. 3 is a perspective view of the motivational and teaching abacus device of the present invention showing the large beads slidably mounted on a rod with semicircular wall mounting brackets supporting the rod adjacent to an end spherical stop for mounting the device on a vertical surface;

FIG. 4 is a partial perspective view showing a horizontal mounting bracket resting on a horizontal surface with the rod of the present invention resting on the horizontal mounting bracket.

### DETAILED DESCRIPTION OF THE INVENTION

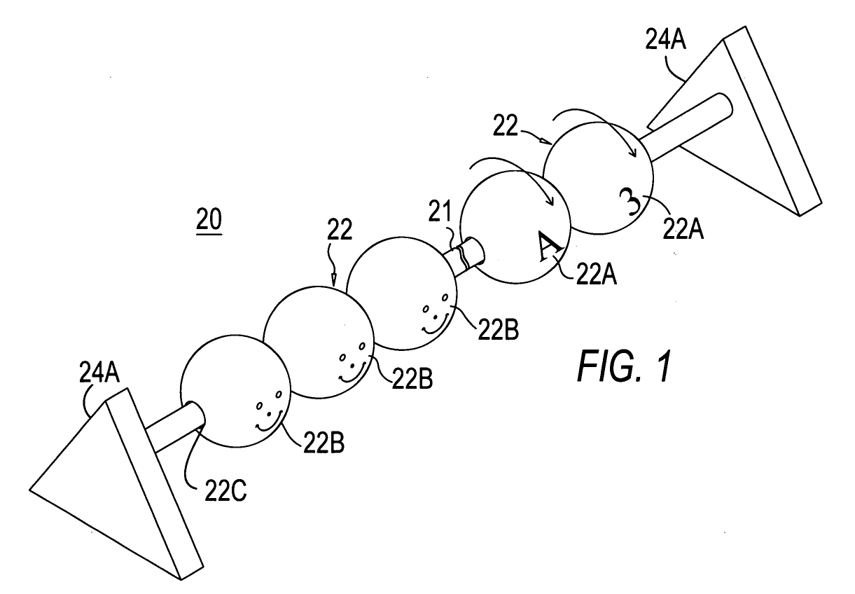

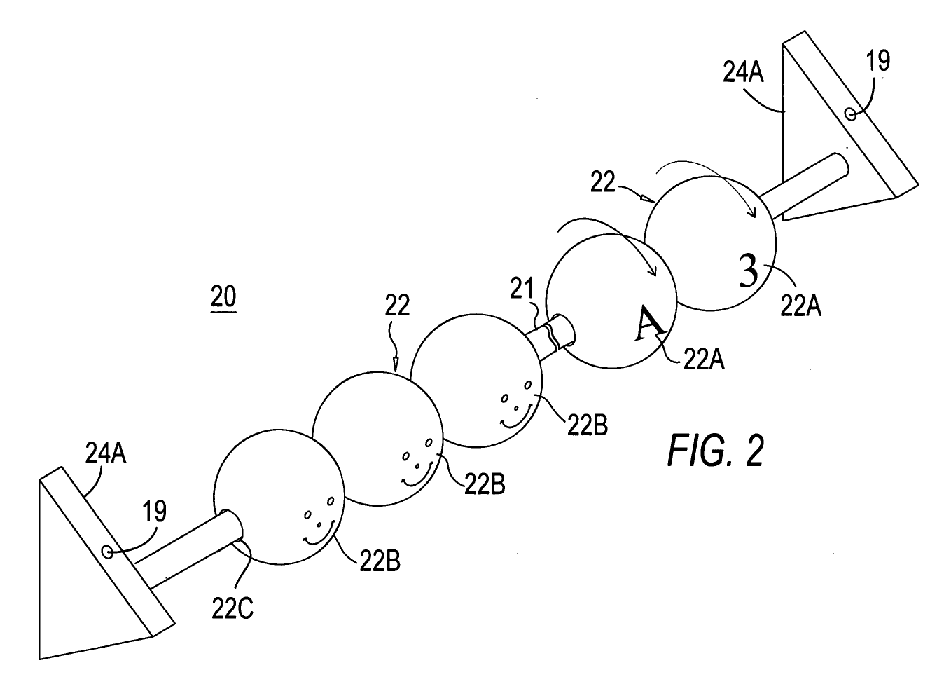

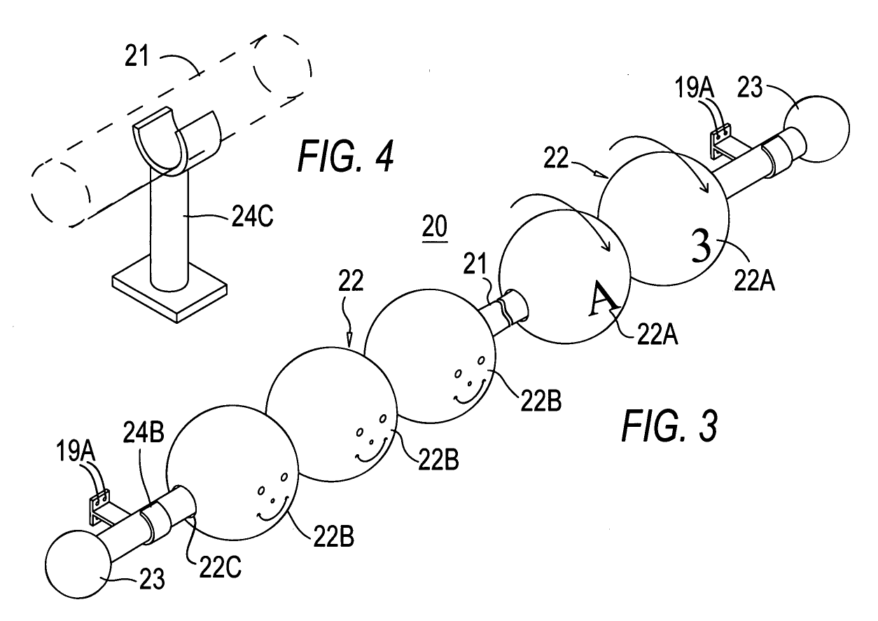

In FIGS. 1-4, a motivational and teaching abacus device 20 comprises a series of large beads 22 mounted on a horizontal rod 21 supported either on a horizontal surface such as a desk, as in FIGS. 1 and 4 or a wall surface, as in FIGS. 2 and 3.

The abacus device 20 comprises an elongated cylindrical rigid horizontal rod 21 and a series of spherical beads 22 mounted along a portion of the length of the horizontal rod 21. Each of the spherical beads 22 have a cylindrical opening 22C through a transverse center of the spherical bead 22. The cylindrical opening 22C is sufficiently large to admit the horizontal rod 21 through the cylindrical opening 22C so that the spherical beads 22 are free to rotate around the horizontal rod 21, as indicated by rotational arrows in FIGS. 1-3, and free to slide along the length of the rod 21.

Each of the spherical beads 22 bear an indicia 22B, such as a smiley face or a star or other motivational indicia, on a front surface for influencing children's behavior so that a spherical bead 22 is moved from a first position to a second position on the horizontal rod 21 as a means of counting an instance of desired behavior. The indicia 22B on the front surface of each of the spherical beads 22 preferably comprises a smiley face 22B which may be used as a means of counting an instance of desired behavior.

Each of the spherical beads 22 bear an educational indicia 22A on a back side for learning one of a series of alphanumeric characters 22A so that the spherical bead 22 is turned to a back surface, as shown by the rotational arrows in FIGS. 1-3, to view and learn the alphanumeric character 22A on the back side; the series of spherical beads 22 together bear indicia 22A for the entire series of alphanumeric characters. The indicia 22A on the back side of each of the spherical beads 22 may comprise a number 22A and the series of spherical beads 22 include all of the numbers of a desired sequence of numbers with one number 22A on each of the spherical beads 22. Alternately, the indicia 22A on the back side of each of the spherical beads 22 may comprise a letter of the alphabet and the series of spherical beads 22 may include all of the letters of the alphabet with one letter 22A on each of the spherical beads 22. The indicia 22A and 22B is of a sufficient size to be viewable by all students in a classroom.

Further alternate embodiments may comprise indicia 22A and 22B on either side of the beads 22 which represent letters, numerals or characters of foreign languages for the purpose of teaching a language, or a combination of languages for teaching bilingual students or a secondary language.

The abacus device 20 also comprises a means for supporting the horizontal rod 21 at each end of the horizontal rod 21.

In FIGS. 1 and 2, the means for supporting the horizontal rod 21 comprises a triangular block 24A at each end of the horizontal rod 21. The triangular block 24A has a flat surface for resting on an external horizontal surface, as shown in FIG. 1 and a surface for mounting on a vertical surface, as shown in FIG. 2. The surface for mounting the rod 21 on a vertical surface has an opening 19 therethrough to receive a fastener for attaching the device 20 to an external vertical surface, such as but not limited to a wall, chalkboard or the front of a desk.

In FIG. 3, the means for supporting the horizontal rod 21 comprises a bracket 24B at each end of the horizontal rod 21. The bracket 24B has a surface for mounting on a vertical surface, such as but not limited to a wall, chalkboard or the front of a desk. The bracket's 24B mounting surface has one or more openings 19A therethrough to receive a fastener for attaching the device 20 to the external vertical surface.

In FIG. 4, the means for supporting the horizontal rod 21 comprises a bracket 24C at each end of the horizontal rod 21, each bracket 24C having a flat surface for resting on an external horizontal surface.

In use, the beads 22 would show smiley faces 22B on the front facing side, then when turned on the rod's 21 axis, as indicated by the rotational arrows in FIGS. 1-3, the smile 22B would face the back of the rod 21 upside down, and the letter 22A or number 22A would appear right side up on the front facing side. Each of the spherical beads 22 bear a smiling face 22B on a front surface for influencing children's behavior so that a spherical bead 22 is moved from a first position to a second position on the horizontal rod 21 as a means of counting an instance of desired behavior. The rewarding indicia 22B may also be used at home to show that a child has accomplished tasks required of them, such as homework or chores.

The indicia 22A on the back of the beads 22 comprise an entire series of alphanumeric characters 22A, with one numeral or letter on each bead 22. A series of numbers 22A may be used to show students how to count by sliding each successive bead 22 along the rod 21 as the students count out loud. Similarly, a series of letters 22A in the alphabet may be taught by sliding each successive bead 22 along the rod 21 as the students say the alphabet out loud.

The indicia 22A and 22B may alternately comprise numbers, characters or letters of a foreign language on the front or back side of the bead 22 to teach a foreign language, or further comprise a combination of languages on either side of the beads 22 to assist in teaching bilingual students or to teach a secondary language.

It is understood that the preceding description is given merely by way of illustration and not in limitation of the invention and that various modifications may be made thereto without departing from the spirit of the invention as claimed.

What is claimed is:

1. A motivational and teaching abacus device comprising:
an elongated cylindrical rigid horizontal rod;
a series of spherical beads mounted along a portion of the length of the horizontal rod, each of the spherical beads having a cylindrical opening through a transverse center of the spherical bead, the cylindrical opening being sufficiently large to admit the horizontal rod through the cylindrical opening so that the spherical beads are free to rotate around the horizontal rod and free to slide along the length of the rod, each of the spherical beads bearing an indicia on a front surface for influencing children's behavior so that a spherical bead is moved from a first position to a second position on the horizontal rod as a means of counting an instance of desired behavior and each of the spherical beads bearing an indicia on a back side for learning one of a series of alphanumeric characters so that the spherical bead is turned to a back surface to view and learn the alphanumeric character on the back side, the series of spherical beads together bearing indicia for the entire series of alphanumeric characters, the indicia being of a sufficient size to be viewable by all students in a classroom;
a means for supporting the horizontal rod at each end of the horizontal rod.

2. The device of claim 1 wherein the indicia on a front surface of each of the spherical beads comprises a smiley face as a means of counting an instance of desired behavior.

3. The device of claim 1 wherein the indicia on a back side of each of the spherical beads comprises a letter of the alphabet and the series of spherical beads includes all of the letters of the alphabet with one letter on each of the spherical beads.

4. The device of claim 1 wherein the indicia on a back side of each of the spherical beads comprises a number and the series of spherical beads includes all of the numbers of a desired sequence of numbers with one number on each of the spherical beads.

5. The device of claim 1 wherein the means for supporting the horizontal rod comprises a block at each end of the horizontal rod, the block having at least one flat surface for resting on an external horizontal surface and at least one surface for mounting on a vertical surface, the at least one surface for mounting on a vertical surface having an opening therethrough to receive a fastener for attaching the device to an external vertical surface.

6. The device of claim 1 wherein the means for supporting the horizontal rod comprises a bracket at each end of the horizontal rod, the bracket having at least one surface for mounting on a vertical surface having an opening therethrough to receive a fastener for attaching the device to an external vertical surface.

7. The device of claim 1 wherein the means for supporting the horizontal rod comprises a bracket at each end of the horizontal rod having at least one flat surface for resting on an external horizontal surface.
